(19) United States
(12) Patent Application Publication
(10) Pub. No.: US 2022/0266604 A1
(43) Pub. Date: Aug. 25, 2022

(54) PRINT HEAD

(71) Applicant: TOSHIBA TEC KABUSHIKI KAISHA, Tokyo (JP)

(72) Inventor: Koji TANIMOTO, Tagata Shizuoka (JP)

(21) Appl. No.: 17/578,998

(22) Filed: Jan. 19, 2022

(30) Foreign Application Priority Data
Feb. 22, 2021 (JP) 2021-025966

(51) Int. Cl. B41J 2/47

(52) U.S. Cl. CPC B41J 2/47

(57) ABSTRACT

A print head includes a first emitting element on a substrate facing a lens. A light output level of the first element is controllable to be within a predetermined range. A second emitting element on the substrate has a light output level that is not controllable to be within the predetermined range. A first driving circuit is connected to the first emitting element. A capacitor is in the first driving circuit and the current supplied to the first emitting element is set by the capacitor voltage. A second driving circuit is connected to the second emitting element to supply current to the second emitting element. A memory stores correction values for the setting of the capacitor voltages for the first and second driving circuits. When capacitor voltage for the second driving circuit is set according to the stored correction value, the capacitor voltage is less than a predetermined threshold.

### CROSS-REFERENCE TO RELATED APPLICATION

This application is based upon and claims the benefit of priority from Japanese Patent Application No. 2021-025966, filed Feb. 22, 2021, the entire contents of which are incorporated herein by reference.

### FIELD

Embodiments described herein relate generally to a print head.

### BACKGROUND

Electrophotographic printers (are widely used. Such a printer includes a print head that includes a plurality of light emitting elements. As a light emitting element, there are ones based on a light emitting diode (LED) and ones based on an organic light emitting diode (OLED). A print head might be provided with light emitting elements for 5120 pixels arranged together along a main scanning direction and a sub-scanning direction orthogonal to the main scanning direction. The printer exposes a photoreceptor drum with light emitted from the light emitting elements, and then prints an image on a sheet that corresponds to a latent image formed on the photoreceptor drum by selective exposure by the light emitting elements.

The image density of the printed image corresponds to quantity of light emitted from each light emitting element. The light quantity emitted from each light emitting element is set by an inter-terminal voltage of a capacitor provided in the driving circuit of the light emitting element. A voltage supply unit (e.g., digital-to-analog conversion circuit) can control the inter-terminal voltage of each capacitor separately to make the quantity of light emitted from each light emitting element be uniform.

To obtain a uniform emission from each light emitting element, the set voltage values (target values) for some capacitors may be significantly different from other capacitors. For example, a defective element may be present in the plurality of light emitting elements, and a sufficient light quantity might not be obtainable from such defective element. However, light quantity correction still typically functions for such a defective element, and thus the set voltage value for the capacitor for the defective element may become extremely large. When the set voltage value between one capacitor's terminals becomes extremely large, an appropriate voltage might not be possible to set between for adjacent capacitors, and as a result, the printed image quality deteriorates.

### BRIEF DESCRIPTION OF THE DRAWINGS

FIG. 1 is a view illustrating an example of a positional relationship between a photoreceptor drum and a print head in an image forming apparatus according to an embodiment.

FIG. 2 is a view illustrating an example of a transparent substrate of a print head.

FIG. 3 is a view illustrating an example of a layout of light emitting elements and drive circuits of a print head.

FIG. 4 is a view illustrating an example of a cross-section of a transparent substrate of a print head.

FIG. 5 is a view illustrating an example of a drive circuit and a light emitting element.

FIG. 6 is a view illustrating an example of a circuit block of a print head.

FIG. 7 is a view illustrating an example of an image forming apparatus.

FIG. 8 is a block diagram of a control system of an image forming apparatus.

FIG. 9 is a view illustrating aspects related to light quantity control within a light emitting element group of a print head.

FIG. 10 is a timing chart illustrating an example of potential setting across capacitor terminals of a print head.

FIG. 11 is a timing chart illustrating an example of a relationship between light quantity control and light emission time control of a print head.

FIG. 12 depicts aspects related to a correction data generation apparatus incorporating a method of creating correction data for causing the light emitting elements to emit light uniformly.

FIG. 13 is a graph illustrating a relationship between a correction value and a light quantity.

FIG. 14 is a flowchart illustrating an example of light quantity correction of a print head.

FIG. 15 is a timing chart illustrating an example of light quantity correction when there is no defective element.

FIG. 16 is a view illustrating an exposure example when a print head includes a defective element.

FIG. 17 is a view illustrating an example of a light quantity measurement result when a print head includes a defective element.

FIG. 18 is a view illustrating an example of correction values computed when there is a defective element in the print head.

FIG. 19 is a view illustrating an example of emitted light quantity after a light quantity correction is applied when a print head includes a defective element.

FIG. 20 is a view illustrating an effect of setting an inappropriate voltage.

FIG. 21 is a view illustrating an effect on an image when a light quantity correction is applied to a print head including a defective element.

FIG. 22 is a flowchart illustrating a second light quantity correction type for a print head.

FIG. 23 is a view illustrating an example of correction values computed by a second light quantity correction when a print head includes a defective element.

FIG. 24 is a view illustrating an example of emitted light quantity after a second light quantity correction is applied when a print head includes a defective element.

FIG. 25 is a view illustrating an effect on an image if a second light quantity correction is applied to a print head including a defective element.

FIG. 26 is a view illustrating an example in which a light emitting element row is longer than a rod lens array and a measured light quantity that corresponds to light emitting elements at both ends is an extremely small value.

FIG. 27 is a view illustrating an example of a light quantity measurement result when a print head includes a light emitting element outside a lens region.

FIG. 28 is a view illustrating an example of correction values computed by a first light quantity correction type when a print head includes a light emitting element outside a lens region.

FIG. 29 is a view illustrating an example of emitted light quantity after a first light quantity correction type is applied when a print head includes a light emitting element outside a lens region.

FIG. 30 is a view illustrating an effect on an image if a first light quantity correction type is applied to a print head including a light emitting element outside a lens region.

FIG. 31 is a view illustrating an example of correction values computed by a second light quantity correction when a print head includes a light emitting element outside a lens region.

FIG. 32 is a view illustrating an example of emitted light quantity after a second light quantity correction is applied when the print head includes a light emitting element outside a lens region.

FIG. 33 is a view illustrating an effect on an image if a second light quantity correction is applied to a print head including a light emitting element outside a lens region.

### DETAILED DESCRIPTION

An object of an embodiment is to provide a print head that prevents reduced image quality.

In general, according to one embodiment, a print head includes a lens, a substrate facing the lens, and light emitting elements on the substrate. A first light emitting element on the substrate is at a position facing the lens and has a light output level that is controllable by current control to be within a predetermined range. A second light emitting element is on the substrate and has a light output level that is not controllable by current control to be within the predetermined range. A first driving circuit is connected to the first light emitting element for supplying current to the first light emitting element. A first capacitor is in the first driving circuit. The current supplied to the first light emitting element by the first driving circuit is set by the inter-terminal voltage of the first capacitor. A second driving circuit is connected to the second light emitting element for supplying current to the second light emitting element. A second capacitor is in the second driving circuit. The current supplied to the second light emitting element by the second driving circuit is set by the inter-terminal voltage of the second capacitor. A memory stores a first correction value for the setting of the inter-terminal voltage of the first capacitor and a second correction value for the setting of the inter-terminal voltage of the second capacitor. When the inter-terminal voltage of the first capacitor is set according to the first correction value, the light output level of the first light emitting element is within the predetermined range. When the inter-terminal voltage of the second capacitor is set according to the second correction value, the inter-terminal voltage of the second capacitor is less than a predetermined threshold level at which output of other light emitting elements in the print head could be affected if the inter-terminal voltage of a capacitor in a driving circuit exceeded the threshold level.

Hereinafter, certain example embodiments related to an image forming apparatus will be described with reference to the drawings. In each drawing, the same reference numerals will be given to the same elements, components, and aspects. The image forming apparatus of an example can be a printer, a copying machine, or a multi-functional peripheral (MFP). In the following, an image forming apparatus that is a MFP will be particularly described.

### Configuration of Print Head

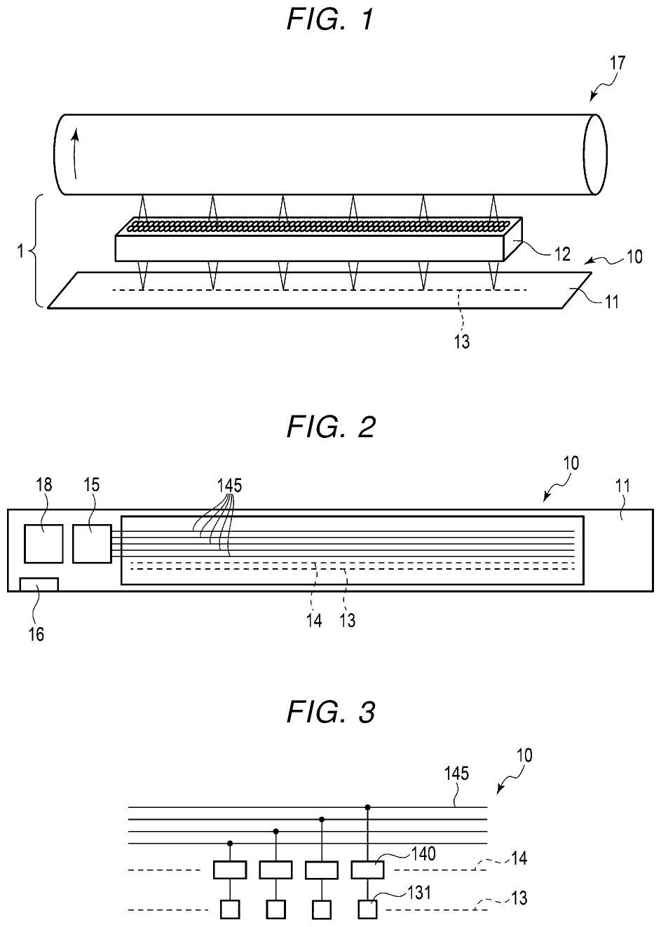

An example of a configuration of a print head for an image forming apparatus according to an embodiment will be described with reference to FIGS. 1 to 6.

FIG. 1 depicts a positional relationship between a photoreceptor drum and a print head.

The image forming apparatus includes a photoreceptor drum 17 and a print head 1 as illustrated in FIG. 1. The print head 1 is disposed facing the photoreceptor drum 17.

The photoreceptor drum 17 rotates in the direction of the arrow. The rotational direction of the photoreceptor drum 17 is called a sub-scanning direction (or Y-axis direction in some contexts), and the direction orthogonal to the sub-scanning direction is called a main scanning direction (or X-axis direction in some contexts). The photoreceptor drum 17 is uniformly charged by an electrostatic charging device and then selectively exposed with the light from the print head 1. The electric potential of the exposed portions decreases relative to the unexposed portions. In other words, the image forming apparatus controls the light emissions of the print head 1 and forms an electrostatic latent image on the photoreceptor drum 17. Controlling the light emission of the print head 1 refers to controlling the timing of light emission and light-off (non-light emission) of the print head 1, and also controlling the light emission quantity.

The print head 1 includes a light emitting unit 10 and a rod lens array 12. The light emitting unit 10 includes a transparent substrate 11 installed facing the rod lens array 12. For example, the transparent substrate 11 is a glass substrate through which light can be transmitted. A light emitting element row 13 formed by a plurality of light emitting elements 131 (see FIG. 3) is on the transparent substrate 11. The print head 1 may include a plurality of light emitting element rows.

The rod lens array 12 collects light from each of the light emitting elements 131 in the light emitting element row 13 to focus light onto the photoreceptor drum 17. Accordingly, an image line is formed on the photoreceptor drum 17. The light emitting elements 131 are formed on the transparent substrate 11. Nominally, the light emission quantity from each light emitting element 131 will be a value within a predetermined range at the facing position with the rod lens array 12 for application of a reference current range to the light emitting element 131. However, as will be described later, some of the light emitting elements 131 may be defective elements or out-of-region elements (elements located outside the light passing region of the lens of the rod lens array 12), thus the light emission quantity at the rod lens array 12 might not be within the predetermined range by current control within the limits of the reference current range.

FIG. 2 illustrates an example of a transparent substrate 11 that has a single row of light emitting elements, but the print head in other examples may have light emitting elements 131 arranged in a plurality of rows.

As illustrated in FIG. 2, the light emitting element row 13 is formed on the transparent substrate 11 along the longitudinal (long dimension) direction of the transparent substrate 11. In the vicinity of the light emitting element row 13, a driving circuit row 14 for driving (causing the emitting of light) the light emitting elements 131 and wirings 145 for supplying signals to the driving circuit row 14 are arranged. Hereinafter, “driving” may be abbreviated to as “DRV”. In FIG. 2, the wirings 145 for driving the light emitting element 131 are grouped on one side of the light emitting element row 13, but in other examples the wirings 145 may be on both sides.

An integrated circuit (IC) 15 and a light quantity correction memory 18 are disposed on one end portion of the transparent substrate 11. In addition, the transparent substrate 11 includes a connector 16. The connector 16 electrically connects the print head 1 to a control system of a printer, a copying machine, or a multifunction machine. This connection enables electric power supply, head control signals, image data transfer, and the like to be provided to the print head 1. Another substrate for sealing/enclosing the light emitting element row 13, the wirings 145, DRV circuits 140, and the like can be attached to the transparent substrate 11. Furthermore, if it is difficult to mount the connector 16 directly to the transparent substrate, a flexible printed circuit (FPC) may be connected to the transparent substrate 11 for connection to the control system.

FIG. 3 is a view illustrating an example of a layout of the light emitting elements 131 and the DRV circuits 140 of the print head 1 according to the embodiment. Although FIG. 3 illustrates an example of the DRV circuits 140 for just one row of light emitting elements 131, the print head 1 may include DRV circuits 140 for a plurality of rows of light emitting elements.

As illustrated in FIG. 3, the light emitting unit 10 of the print head 1 includes the light emitting element row 13 in which the plurality of light emitting elements 131 are arranged and the DRV circuit row 14 in which the plurality of DRV circuits 140 are arranged. The DRV circuits 140 cause the light emitting elements 131 to emit light based on signals supplied to each DRV circuit 140. Signals in this context refers to a sample and hold signal 21 (SH signal 21), a light emission level signal 22, and a pulse width modulation (PWM) signal 32) supplied via the wirings 145.

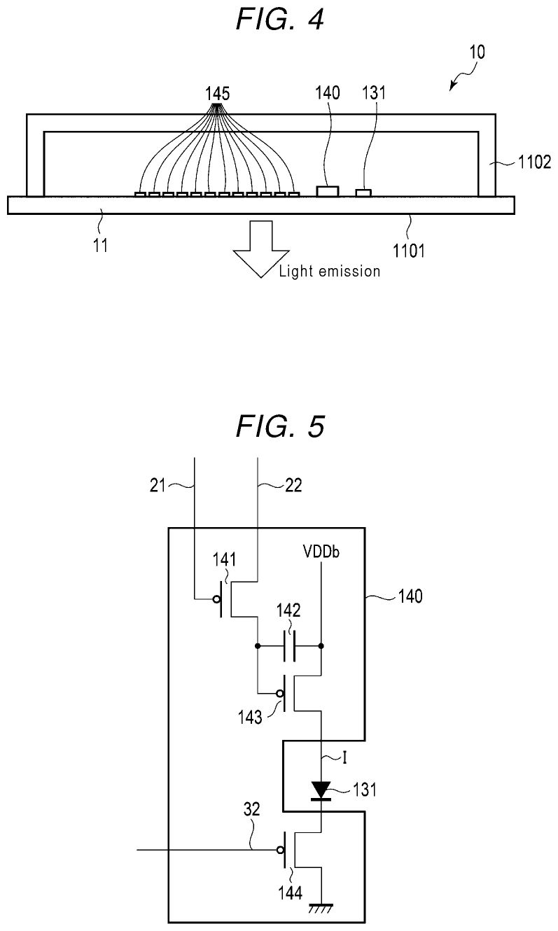

FIG. 4 is a view illustrating an example of a cross-section of the transparent substrate 11 of the print head 1 according to an embodiment.

As illustrated in FIG. 4, the light emitting unit 10 includes a plurality of light emitting elements 131, a plurality of DRV circuits 140, and the wirings 145 which are disposed on a side of the transparent substrate 11 opposite from a reference surface 1101 of the transparent substrate 11. In addition, the light emitting unit 10 includes a sealing glass 1102. The plurality of light emitting elements 131, the plurality of DRV circuits 140, and the wiring 145 are disposed in the space enclosed by the transparent substrate 11 and the sealing glass 1102. The light from the light emitting elements 131 passes through the thickness of the transparent substrate 11 and toward the photoreceptor drum 17 facing the reference surface 1101.

FIG. 5 is a view illustrating an example of the DRV circuits 140 and the light emitting elements 131.

In this example, each DRV circuit 140 is configured with low-temperature polysilicon thin film transistors 141, 143, and 144 and a capacitor 142. The SH signal 21 becomes a low level (a logic low value) if the light emission intensity of the light emitting element 131 connected to the DRV circuit 140 is to be changed. If the SH signal 21 reaches a low level, the transistor 141 is turned on, and the inter-terminal voltage of the capacitor 142 connected to the transistor 141 and the transistor 143 changes depending on the voltage of the light emission level signal 22. In other words, the inter-terminal voltage of the capacitor 142 changes (is adjusted) depending on a correction value, and the current supplied to the light emitting element 131 for light emission is determined by the inter-terminal voltage of the capacitor 142.

If the SH signal 21 becomes a high level (a logic high value), the transistor 141 is turned off and the inter-terminal voltage of the capacitor 142 is held. Even if the voltage of the light emission level signal 22 changes, the inter-terminal voltage level of the capacitor 142 does not change while the SH signal 21 is at the high level. A current that corresponds to the voltage held by the capacitor 142 (the inter-terminal voltage of the capacitor 142) flows through the light emitting element 131 connected to a signal line I of the DRV circuit 140. In other words, the light emitting element 131 emits light with a light quantity that corresponds to the inter-terminal voltage of the capacitor 142 in the DRV circuit 140. The certain DRV circuits 140 (and associated light emitting elements 131) are selected from the plurality of DRV circuits 140 by application of the SH signal 21. The light emission intensity from the associated light emitting elements 131 is set by the light emission level signal 22, and the set light emission intensity can be maintained. In the following, an inter-terminal voltage of a capacitor is referred to for simplicity as the voltage of the capacitor or alternatively the voltage across the capacitor.

The transistor 144 in the DRV circuit 140 switches between current supply and non-supply (ON or OFF of current supply) for the light emitting element 131. The PWM signal 32 connected to the transistor 144 controls the light emission and light-off of the light emitting element 131 (determines the light emission time per line cycle). If the transistor 144 is turned on by the PWM signal 32, a current flows through the light emitting element 131 and the light emitting element 131 emits light. If the transistor 144 is turned off by the PWM signal 32, a current does not flow through the light emitting element 131 and the light emitting element 131 turns the light off.

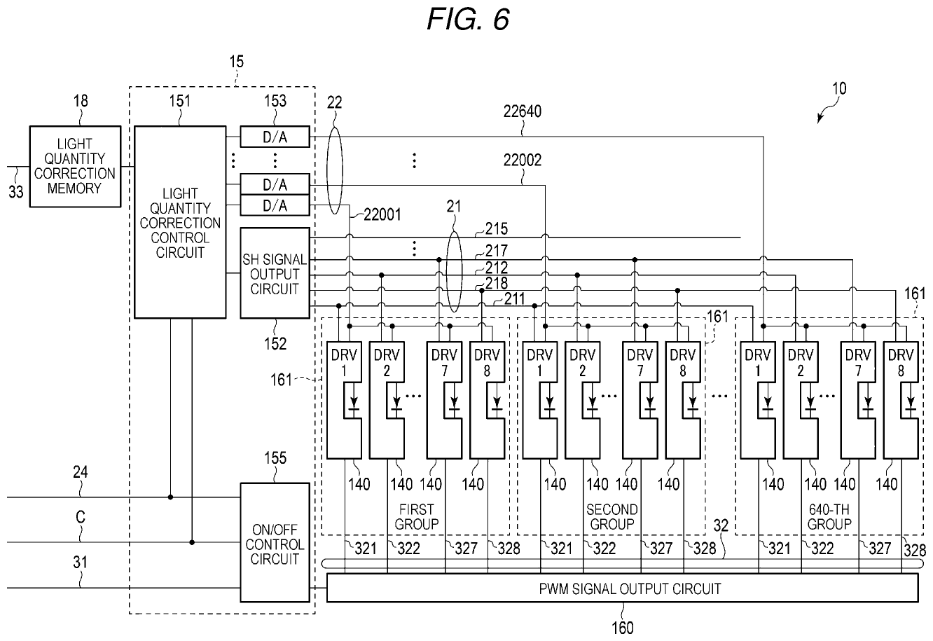

FIG. 6 illustrates an example of a print head circuit block that corresponds to one row of light emitting elements 131.

As illustrated in FIG. 6, the light emitting unit 10 includes the print head circuit block including an IC 15, a light quantity correction memory 18, and first to N-th light emitting element groups 161 (where N is an integer of two or more; for example, N=640). Each light emitting element group 161 includes first to M-th DRV circuits 140 (where M is an integer of two or more; for example, M=8). As illustrated in FIG. 6, the first to M-th DRV circuits 140 provided in each light emitting element group 161 can be referred to as DRV 1 through DRV 8, respectively. The IC 15 includes a light quantity correction control circuit 151, an SH signal output circuit 152, a digital to analog (D/A) conversion circuit 153, an ON and OFF control circuit 155, and the like. In some contexts, IC 15 may be referred to as a voltage control circuit, a light emission controller, or the like.

The light quantity correction memory 18 stores a correction value (first correction value) for each of the light emitting elements 131 to cause emission of light from the light emitting element 131 within a predetermined range of light quantity (intensity). However, for those light emitting elements 131 that cannot emit light with the predetermined range even with the correction value applied thereto, a separately determined correction value (a second correction value) is stored. The light quantity correction memory 18 outputs the correction values to the light quantity correction control circuit 151. A light emission controller of an image forming apparatus may read the correction values from the light quantity correction memory 18 and write the correction values into the light quantity correction control circuit 151.

A horizontal synchronizing signal 24 and an image data writing clock C (clock signal) are input to the light quantity correction control circuit 151 via the connector 16. The horizontal synchronizing signal 24, the image data writing clock C, and the image data 31 are input to the ON and OFF control circuit 155 via the connector 16. The horizontal synchronizing signal 24 resets the count values of the light quantity correction control circuit 151 and the ON and OFF control circuit 155.

The light quantity correction control circuit 151 outputs a signal synchronized with the image data writing clock C. In other words, the light quantity correction control circuit 151 outputs a correction value to each D/A conversion circuit 153 in synchronization with the image data writing clock C. Accordingly, the D/A conversion circuit 153 outputs a voltage along the correction value. The SH signal output circuit 152 supplies the SH signal 21 to the DRV circuit 140, the ON and OFF control circuit 155 controls ON and OFF of the PWM signal 32, and a PWM signal output circuit 160 supplies the individual PWM signals 32 (PWM signal 321, 322, . . . and 328) to the DRV circuits 140. The inter-terminal voltage of the capacitor is sequentially set by the SH signal 21 from the SH signal output circuit 152 and the light emission level signal 22 from the D/A conversion circuit 153. In other words, the SH signal output circuit 152 and the D/A conversion circuit 153 function as voltage setting means.

Each DRV circuit 140 generates a driving signal that causes the light emitting element 131 to emit light based on the respective individual SH signals 21 (211, 212, . . . and 218) output by the IC 15, the respective individual light emission level signals 22 (22001, 22002, . . . and 22640), and the respective individual PWM signals 32. Each DRV circuit 140 supplies the driving signal (current) to its associated light emitting element 131.

### Configuration of Image Forming Apparatus

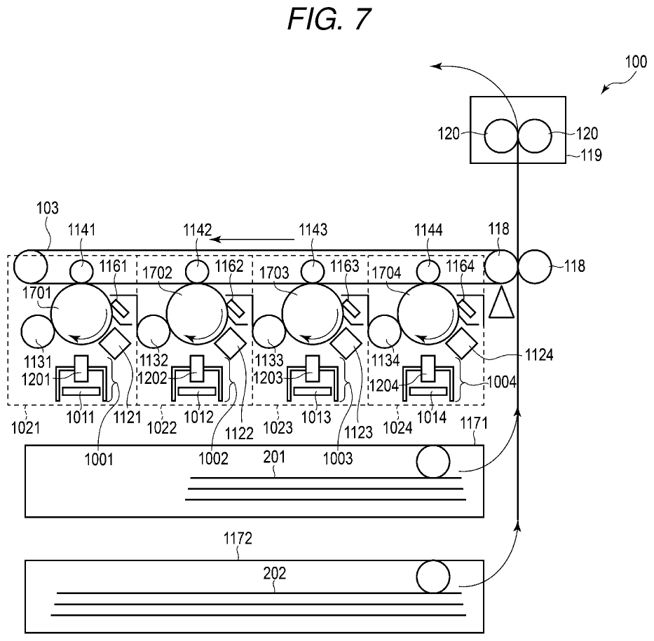

FIG. 7 illustrates an example of a quintuple tandem type color image forming apparatus, but the print head 1 can also be applied to a monochrome image forming apparatus.

As illustrated in FIG. 7, an image forming apparatus 100 includes an image forming unit 1021 that forms a yellow (Y) toner image, an image forming unit 1022 that forms a magenta (M) toner image, an image forming unit 1023 that forms a cyan (C) toner image, and an image forming unit 1024 that forms a black (K) toner image. The image forming units 1021, 1022, 1023, and 1024, respectively, and transfer the toner images to a transfer belt 103. Accordingly, a full-color image is formed on the transfer belt 103 as overlapped toner images of different colors.

The image forming unit 1021 that forms a yellow (Y) image includes a print head 1001, and the print head 1001 includes a light emitting unit 1011 and a rod lens array 1201. The image forming unit 1021 has an electrostatic charger 1121, the print head 1001, a developing device 1131, a transfer roller 1141, and a cleaner 1161 around a photoreceptor drum 1701. The print head 1001 corresponds to the print head 1, the light emitting unit 1011 corresponds to the light emitting unit 10, the rod lens array 1201 corresponds to the rod lens array 12, and the photoreceptor drum 1701 corresponds to the photoreceptor drum 17.

The image forming unit 1022 that forms a magenta (M) image includes a print head 1002, and the print head 1002 includes a light emitting unit 1012 and a rod lens array 1202. The image forming unit 1022 has an electrostatic charger 1122, the print head 1002, a developing device 1132, a transfer roller 1142, and a cleaner 1162 around a photoreceptor drum 1702. The print head 1002 corresponds to the print head 1, the light emitting unit 1012 corresponds to the light emitting unit 10, the rod lens array 1202 corresponds to the rod lens array 12, and the photoreceptor drum 1702 corresponds to the photoreceptor drum 17.

The image forming unit 1023 that forms a cyan (C) image includes a print head 1003, and the print head 1003 includes a light emitting unit 1013 and a rod lens array 1203. The image forming unit 1023 has an electrostatic charger 1123, the print head 1003, a developing device 1133, a transfer roller 1143, and a cleaner 1163 around a photoreceptor drum 1703. The print head 1003 corresponds to the print head 1, the light emitting unit 1013 corresponds to the light emitting unit 10, the rod lens array 1203 corresponds to the rod lens array 12, and the photoreceptor drum 1703 corresponds to the photoreceptor drum 17.

The image forming unit 1024 that forms a black (K) image includes a print head 1004, and the print head 1004 includes a light emitting unit 1014 and a rod lens array 1204. The image forming unit 1024 includes an electrostatic charger 1124, the print head 1004, a developing device 1134, a transfer roller 1144, and a cleaner 1164 around a photoreceptor drum 1704. The print head 1004 corresponds to the print head 1, the light emitting unit 1014 corresponds to the light emitting unit 10, the rod lens array 1204 corresponds to the rod lens array 12, and the photoreceptor drum 1704 corresponds to the photoreceptor drum 17.

The electrostatic chargers 1121, 1122, 1123, and 1124 uniformly charge the photoreceptor drums 1701, 1702, 1703, and 1704, respectively. The print heads 1001, 1002, 1003, and 1004 respectively expose the photoreceptor drums 1701, 1702, 1703, and 1704 by the light emission of the light emitting elements 131, and form electrostatic latent images on the photoreceptor drums 1701, 1702, 1703, and 1704. The developing device 1131, the developing device 1132, the developing device 1133, and the developing device 1134 respectively adhere (develop) a yellow toner, a magenta toner, a cyan toner, and a black toner, to the electrostatic latent on the photoreceptor drums 1701, 1702, 1703, and 1704.

The transfer rollers 1141, 1142, 1143, and 1144 transfer the toner images from the photoreceptor drums 1701, 1702, 1703, and 1704 to the transfer belt 103. The cleaners 1161, 1162, 1163, and 1164 remove any toner which is not transferred and left on the photoreceptor drums 1701, 1702, 1703, and 1704, so the drums are ready for the next image formation.

A paper sheet 201 (print medium) having a first size (small size) is stored in a paper sheet cassette 1171. A paper sheet 202 (print medium) having a second size (large size) is stored in a paper sheet cassette 1172.

A toner image is transferred from the transfer belt 103 by a transfer roller pair 118 to the paper sheet 201 or paper sheet 202. The paper sheet 201 or paper sheet 202 is then heated and pressed by a fixing roller 120 of a fixing unit 119. The toner image is firmly fixed on the paper sheet 201 or 202 by the heating and pressing of the fixing roller 120. By repeating the above-described process operation, the image forming operation can be continuously performed on paper sheet after paper sheet in a back to back manner.

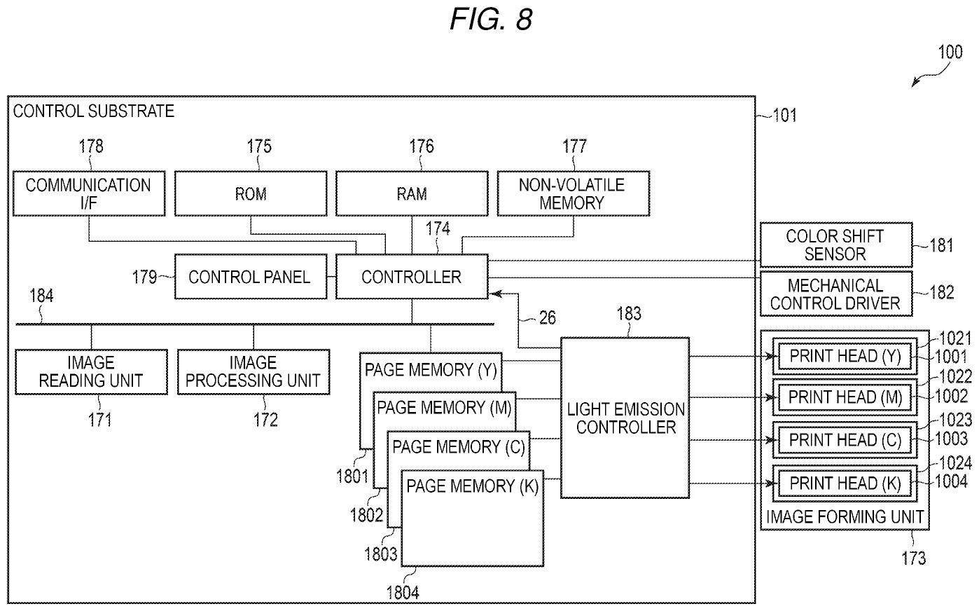

FIG. 8 is a block diagram illustrating an example of a control system of the image forming apparatus according to the embodiment.

As illustrated in FIG. 8, the image forming apparatus 100 includes a control substrate 101 (also referred to as a circuit board, controller board, a printed circuit board, a controller card, or the like). The control substrate 101 includes an image reading unit 171, an image processing unit 172, an image forming unit 173, a controller 174, a read only memory (ROM) 175, a random access memory (RAM) 176, a non-volatile memory 177, a communication I/F 178, a control panel 179, page memories 1801, 1802, 1803, and 1804, a light emission controller 183, and an image data bus 184. Furthermore, the image forming apparatus 100 in this example includes a color shift sensor 181 and a mechanical control driver 182 (e.g., a motor controller or the like). The image forming unit 173 includes the image forming units 1021, 1022, 1023, and 1024.

The ROM 175, the RAM 176, the non-volatile memory 177, the communication I/F 178, the control panel 179, the color shift sensor 181, the mechanical control driver 182, and the light emission controller 183 are connected to the controller 174.

The image reading unit 171, the image processing unit 172, the controller 174, the page memories 1801, 1802, 1803, and 1804 are connected to the image data bus 184. The page memories 1801, 1802, 1803, and 1804 respectively output Y, M, C, or K image data 31. The light emission controller 183 is connected to the page memories 1801, 1802, 1803, and 1804, and the Y image data 31 from the page memory 1801, the M image data 31 from the page memory 1802, the C image data 31 from the page memory 1803, and the K image data 31 from the page memory 1804 are input thereto. The print heads 1001, 1002, 1003, and 1004 are connected to the light emission controller 183. The light emission controller 183 sends the corresponding image data 31 (Y, M, C, or K) to the print heads 1001, 1002, 1003, or 1004.

The controller 174 includes one or more processors and controls operations such as image reading (scanning), image processing, and image formation according to various programs stored in at least one of the ROM 175 or the non-volatile memory 177.

The controller 174 may also send the image data of a test pattern to the page memories 1801, 1802, 1803, and 1804 for printing a test pattern. The color shift sensor 181 detects the test pattern and outputs a detection signal to the controller 174. The controller 174 can recognize the positional relationship of each color in the test pattern from the output of the color shift sensor 181. Furthermore, the controller 174 selects the paper sheet cassette 1171 or 1172 for feeding paper sheets on which an image is to be formed through control of the mechanical control driver 182.

The ROM 175 stores various programs or the like necessary for the control of the controller 174. The various programs include a light emission control program of the print head. The light emission control program is a program for controlling the timing of light emission and light-off (non-light emission) based on the image data (the data indicating the particular image to the be printed such as supplied by a print job).

The RAM 176 temporarily stores the data necessary for the control of the controller 174. The non-volatile memory 177 stores a part or all of various programs and various parameters.

The mechanical control driver 182 controls the operation of a motor or the like necessary for printing according to the instruction of the controller 174. The communication I/F 178 sends various pieces of information to the outside (e.g., an external device) and also receives various pieces of information from the outside. For example, the communication I/F 178 acquires image data comprising a plurality of image lines. The image forming apparatus 100 prints the image data acquired via the communication I/F 178 by the print function. The control panel 179 receives operation inputs from the user and service personnel.

The image reading unit 171 optically reads the image of a document set on a document holder, acquires the image data including the plurality of image lines, and outputs the image data to the image processing unit 172. The image processing unit 172 executes various types of image processing such as correction with respect to the image data input via the communication I/F 178 or the image data from the image reading unit 171. The page memories 1801, 1802, 1803, and 1804 store the image data processed by the image processing unit 172. The controller 174 edits the image data on the page memories 1801, 1802, 1803, and 1804 so as to match the print position or the print head. The image forming unit 173 forms an image based on the image data stored in the page memories 1801, 1802, 1803, and 1804. In other words, the image forming unit 173 forms an image based on the light emission (light emission and light-off state) of each of the light emitting elements 131 that correspond to the image data.

The light emission controller 183 includes one or more processors and controls the light emission of the light emitting element 131 based on the image data according to various programs stored in at least one of the ROM 175 and the non-volatile memory 177. In other words, the light emission controller 183 outputs a driving signal for causing the light emitting element 131 to emit light to the light emitting element 131 at a predetermined timing.

### Light Quantity Control

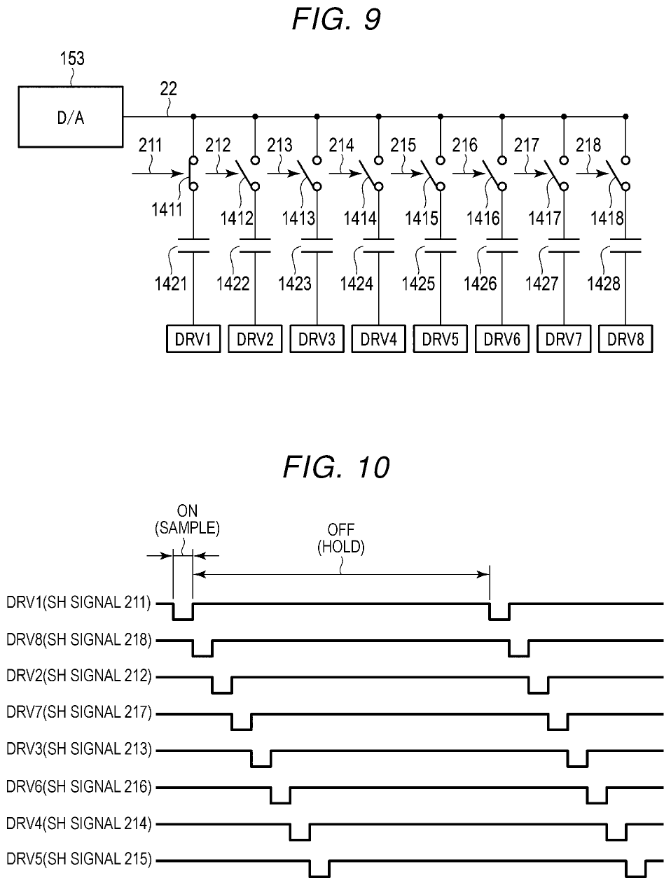

FIG. 9 is a view illustrating light quantity control within the light emitting element group 161 of the print head according to the embodiment.

In FIG. 6, each light emitting element group 161 includes eight DRV circuits 140 (DRV 1 to DRV 8) and the eight light emitting elements 131 respectively connected to the eight DRV circuits 140. The transistor 141 and the capacitor 142 of each DRV circuit 140 in a light emitting element group 161 are illustrated in FIG. 9 as eight switches 1411 to 1418 and eight capacitors 1421 to 1428 corresponding to the DRV 1 to the DRV 8, respectively. The SH signals 211 to 218 output by the SH signal output circuit 152 are signals for opening and closing (setting ON and OFF states) the switches 1411 to 1418, and correspond to the SH signals 21 described above with reference to FIG. 5. The light quantity control of the print head 1 is performed on a light emitting element group 161 basis (e.g., groups of eight DRV circuits 140).

The light quantity setting for the eight DRV circuits 140 (DRV 1 to DRV 8) in a light emitting element group 161 will be described with reference to the timing chart of FIG. 10.

The SH signal 211 reaches a low level, and the switch 1411 of the DRV 1 is closed (turned on). In synchronization with this, the D/A conversion circuit 153 outputs the light emission level signal 22 suitable for the light quantity to be output by the light emitting element 131 connected to the DRV 1, and the voltage thereof is set for the capacitor 1421 (sample). If the SH signal 211 reaches a high level, the switch 1411 is opened (OFF), and the voltage of the light emission level signal 22 at this time is held in the capacitor 1421. After the switch 1411 is opened (OFF), even if the voltage of the light emission level signal 22 changes, the voltage level of the capacitor 1421 does not change.

Next, the SH signal 218 reaches a low level, and the switch 1418 of the DRV 8 is closed (turned on). In synchronization with this, the D/A conversion circuit 153 outputs the light emission level signal 22 suitable for the light quantity to be output by the light emitting element 131 connected to the DRV 8, and the voltage thereof is set for the capacitor 1428 (sample). If the SH signal 218 reaches a high level, the switch 1418 is opened (OFF), and the voltage of the light emission level signal 22 at this time is held in the capacitor 1428. After the switch 1418 is opened (OFF), even if the voltage of the light emission level signal 22 changes, the voltage of the capacitor 1428 does not change.

Hereinafter, the same operation is executed in order of the DRV 2, the DRV 7, the DRV 3, the DRV 6, the DRV 4, and the DRV 5, and the light quantity is set for the eight DRV circuits provided in the light emitting element group 161.

In this manner, the timing of opening and closing (ON and OFF) of the switches 1411 to 1418 is different depending on the SH signals 211 to 218, and the signal output level of the D/A conversion circuit 153 is changed in synchronization with the SH signals 211 to 218. Accordingly, the light quantity of the light emitting elements 131 connected to the DRV 1 to DRV 8 can be controlled.

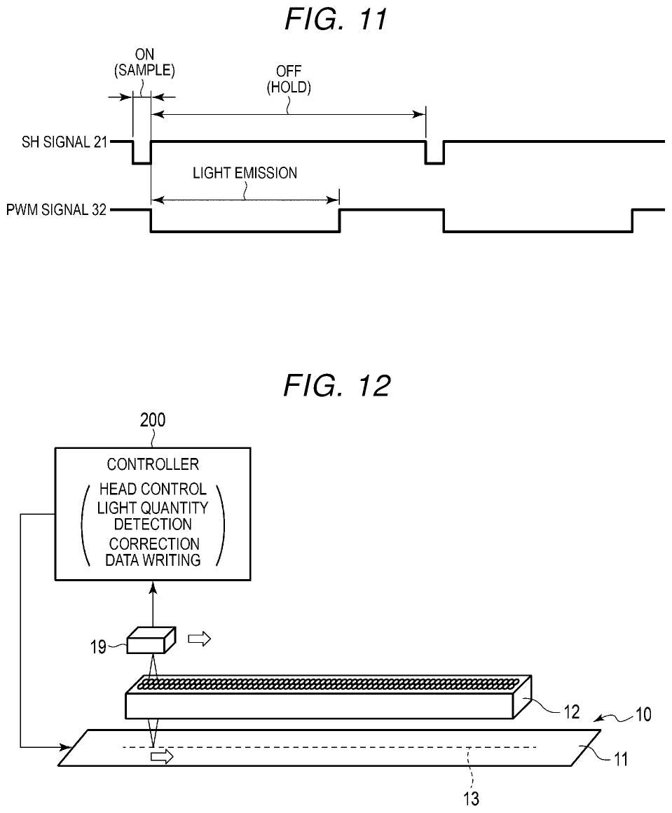

FIG. 11 is a timing chart illustrating an example of a relationship between the light quantity control and light emission time control of the print head according to the embodiment.

As illustrated in FIG. 11, if the PWM signal 32 is input while the set voltage is being held by the capacitor 142, the light emitting element 131 emits light at the set light quantity. In other words, the SH signal 21 and the PWM signal 32 are output in synchronization. Further, the light emission time per line cycle is controlled by the length of the PWM signal 32. Furthermore, similarly to the SH signal 21, the PWM signal 32 is also output at individual timings for each of the DRV 1 to DRV 8.

In a series of light quantity control operations, if the voltage difference is extremely large in the light emission level signal 22 output by the D/A conversion circuit 153 to a capacitor in which the voltage is set first (hereinafter, referred to as an initial stage) and a capacitor in which the voltage is continuously set (hereinafter, referred to as a subsequent stage), the capacitor 142 in the subsequent stage may not be charged (or discharged) in time, and the target correct voltage (light emission level) cannot be set in the capacitor 142 in the subsequent stage. In other words, in the control order illustrated in FIG. 10, for example, the target correct voltage cannot be set in the capacitor 1428 in the subsequent stage due to the effect of the set voltage in the capacitor 1421 in the initial stage. If the target correct voltage cannot be set, the emitted light quantity of the light emitting element 131 is affected, and there is a concern that the image quality deteriorates. In the present embodiment, the deterioration of image quality is prevented by a light quantity correction.

Furthermore, a series of light quantity control and light emission operation a cycle order of the DRV 1, the DRV 8, the DRV 2, the DRV 7, the DRV 3, the DRV 6, the DRV 4, the DRV 5, as illustrated in FIG. 10, are performed to ensure continuity of light emission timing between adjacent light emitting element groups 161. For example, since the DRV 1 of one light emitting element group 161 may be adjacent to the DRV 8 of an adjacent light emitting element group 161, it is desirable that the light quantity control and the light emission operation for the DRV 1 and the DRV 8 in each element group are as described above.

FIG. 12 is a schematic view of a correction data generation apparatus illustrating a method of creating correction data for causing the light emitting element 131 of the print head 1 to emit light with a uniform light quantity.

The correction data generation apparatus includes a light quantity measurement sensor 19 and a controller 200. The light quantity measurement sensor 19 is a sensor that receives light output by the light emitting element 131 of the print head 1 after passing through the lens and outputs a voltage proportional to the intensity (light quantity) of the light as a detection signal.

As illustrated in FIG. 12, the light quantity measurement sensor 19 is positioned on the opposite side of the transparent substrate 11 with respect to the rod lens array 12.

The controller 200 has a print head control function equivalent to that of the light emission controller 183 described above and also has an arithmetic function for obtaining the correction data and a control function for moving the sensor.

To measure the light quantity of all of the light emitting elements 131 of the print head 1, the controller 200 can move the light quantity measurement sensor 19 to the positions of each of the light emitting elements 131 to be measured. The light quantity measurement sensor 19 may incorporate, or be attached to, a light quantity measurement sensor moving apparatus. The controller 200 causes the light emitting elements 131 to emit light so the light quantity of each light emitting element 131 can be measured based on the detection signal from the light quantity measurement sensor 19.

For example, the controller 200 controls the output voltage of the light emission level signal 22 from the D/A conversion circuit 153 and the PWM signal 32, and causes each light emitting element 131 to sequentially emit light while moving the light quantity measurement sensor 19. The light quantity measurement sensor 19 detects the light quantity emitted from the light emitting elements 131 and outputs a corresponding detection signal.

When measuring light quantity, the controller 200 may write any value into the light quantity correction memory 18 of the print head 1 and then send the image data 31 to the print head 1, accordingly, it is possible to cause any light emitting element 131 to emit light at any possible light emission level. Furthermore, the controller 200 may also cause light to be emitted at any possible light emission level by directly accessing the light quantity correction control circuit 151 without going through the light quantity correction memory 18.

FIG. 13 is a graph illustrating the light quantity of the light emitting element with respect to the correction value. FIG. 13 illustrates the relationship between the correction value and the light quantity for elements A and B that normally emit light and an element C that does not emit light normally.

First, the elements A and B that normally emit light will be described.

As illustrated in FIG. 13, the light quantity is larger if the second reference value is set than that if the first reference value is set as the correction value for both the element A and the element B. The level illustrated by the dotted line in FIG. 13 is a target light quantity. In the first reference value, both the elements A and B have a light quantity smaller than the target light quantity. In the second reference value, both the elements A and B exceed the target light quantity. Therefore, it can be understood that the correction value (first correction value) for outputting the target light quantity is between the first reference value and the second reference value for both the elements A and B. The correction value for outputting the target value can be calculated and obtained. It can be understood that the point indicating the light quantity with respect to the first reference value and the point of the light quantity with respect to the second reference value may be connected to each other by a straight line, and the point at which the straight line intersects the target light quantity may be obtained. The correction values of each of the respective intersections PA and PB are the correction values for outputting the target light quantity. Furthermore, even if the correction value for outputting the target light quantity is not between the first reference value and the second reference value, if there is a point where the straight line intersects the target light quantity within the range of the settable correction value, the correction value for outputting the target light quantity can be obtained. In this manner, the elements A and B are elements in which the light quantity at the facing position across the rod lens array 12 satisfies the reference by correction value setting (current control) and becomes a value within a predetermined range.

The element C is an element in which the light emitting element 131 does not emit light normally because the DRV circuit 140 or the light emitting element 131 is defective, or the light does not come out of the lens even if the light emitting element 131 emits light.

In the element C, the first and second reference values and the first and second measured light quantities that correspond to the first and second reference values are not in a proportional relationship. In the element C, the light quantity does not increase even if the correction value is increased to increase the voltage between the capacitor terminals. Otherwise, even if the light quantity increases, the target light quantity is not reached. Therefore, in a case of the element C, the straight line that connects the point indicating the light quantity with respect to the first reference value and the point of the light quantity with respect to the second reference value, does not intersect the target light quantity. In other words, the element C is an element in which the light quantity at the facing position across the rod lens array 12 does not satisfy the reference by correction value setting (current control) and becomes a value deviated from a predetermined range.

In this manner, an element that cannot emit light with a target light quantity even if any correction value is set cannot compute an appropriate correction value for setting the emitted light quantity to the target light quantity, and an inappropriate correction value is computed. For example, since the light quantity is below the target light quantity, the maximum value is computed as the correction value. There is a concern that inappropriate correction values affect the light emission of other light emitting elements and cause deterioration of image quality. Hereinafter, an element exhibiting characteristics similar to those of the element C is referred to as a defective element.

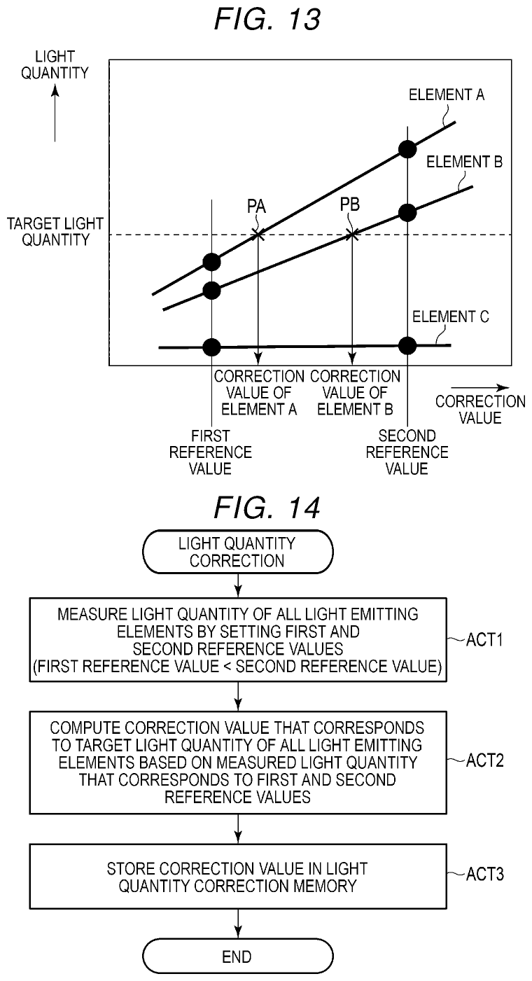

FIG. 14 is a flowchart illustrating an example of the light quantity correction performed to cause the print head according to the embodiment to emit light with a uniform light quantity.

The controller 200 sets the first and second reference values (first reference value<second reference value) as the light quantity correction value, and measures the light quantity of all of the light emitting elements 131. The light quantity measurement sensor 19 detects the light quantity after passing through the lens from the light emitting element 131 that corresponds to the light emission control of the controller 200, and outputs a detection signal. The controller 200 measures the light quantity on the opposite side of the transparent substrate 11 across the rod lens array 12 from all of the light emitting elements 131 after passing through the lens, based on the detection signal from the light quantity measurement sensor 19 (ACT 1).

Next, the controller 200 computes a correction value that corresponds to the target light quantity of each of the light emitting elements 131, based on the measured light quantity that corresponds to the first and second reference values (ACT 2). For example, in a case of the element A and the element B that normally emit light as described in FIG. 13, the correction values that correspond to the intersections PA and PB are computed. For the defective element C described with reference to FIG. 13, a correction value that is a target light quantity cannot be computed. Since the light quantity of the element C is insufficient, the maximum value is computed as the correction value.

Next, the controller 200 writes the correction values of each of the light emitting elements into the light quantity correction memory 18 (ACT 3). The print head that completed the light quantity correction in this manner controls the current flowing through the light emitting element 131 according to the correction value written into the light quantity correction memory 18, and the light emitting element 131 emits light at the target light quantity.

In other words, the output voltage of the D/A conversion circuit 153 is controlled according to the correction value written into the light quantity correction memory 18, the inter-terminal voltage of the capacitor 142 is controlled by the output voltage of the D/A conversion circuit 153, the current flowing through the light emitting element 131 is controlled by the inter-terminal voltage of the capacitor 142, and the light emitting element 131 emits light with a target light quantity. However, a defective element such as the element C cannot emit light with a target light quantity even if the maximum value is set to the correction value.

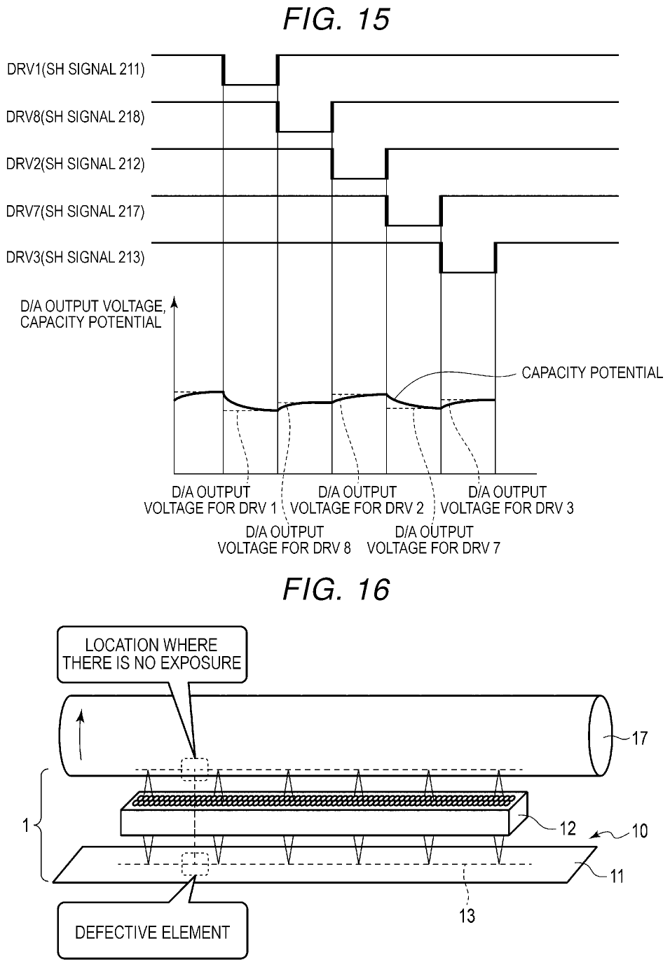

FIG. 15 is a timing chart illustrating an example of the light quantity correction if there is no defective element.

For example, in order to make the light emission timings of the adjacent light emitting elements 131 continuous, the IC 15 sets the voltage between the terminals of the capacitor 142 of the DRV circuit 140 in order illustrated in FIGS. 10 and 15. In other words, the SH signal 21 sets the voltage between the capacitor terminals of each of DRV circuits in order of the DRV 1, the DRV 8, the DRV 2, the DRV 7, the DRV 3, the DRV 6, the DRV 4, the DRV 5, the DRV 1 . . . .

Further, the D/A output voltage (broken line) of the light emission level signal 22 from the D/A conversion circuit 153 changes at the timing assigned to each of the DRV circuits 140 depending on the correction value. The capacitor inter-terminal voltage (solid line) becomes equal to the D/A output voltage within the time allocated to each of the DRV circuits 140, and is held at the rising timing of the SH signal. As a result, all of the light emitting elements 131 are ready to emit light with a uniform light quantity.

FIG. 16 is a view illustrating an exposure example of a case where the print head according to the embodiment includes the defective element.

As illustrated in FIG. 16, if the defective element is provided in the light emitting element row, the position that corresponds to the element on the photoreceptor drum 17 cannot be exposed. If such a print head is measured by the light quantity measuring method illustrated in FIG. 12, the measurement result that corresponds to the defective element illustrates an extremely small value as described in FIG. 14. In the light quantity correction for the defective element, for example, the correction value is calculated so as to maximize the light quantity, and thus, the correction value illustrates an extremely large value. Therefore, the voltage value set between the terminals of the capacitor 142 that corresponds to the defective element is larger than the voltage value set between the terminals of the capacitor 142 that corresponds to the other non-defective element.

In the following, an attempted correction method that occurs when a defective element exists in the light emitting element row of the print head and the voltage set between the terminals of the capacitor 142 of the DRV circuit 140 for the defective element is allowed to become significantly different from the voltage set between the terminals of the capacitor 142 of the DRV circuit 140 for a normal element, is called a first light quantity correction or a first type correction method.

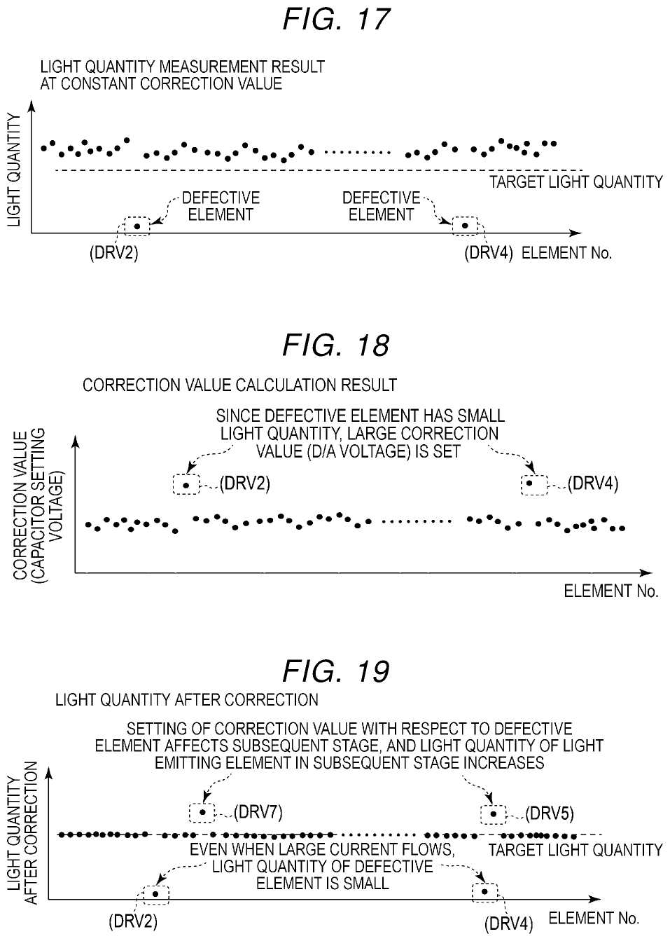

FIG. 17 is a view illustrating an example of a result of measuring the light quantity against the second reference value when the print head includes a defective element. FIG. 18 is a view illustrating an example of the correction value computed by a first light quantity correction when the print head includes the defective element. FIG. 19 is a view illustrating an example of the light quantity after the first light quantity correction is applied when the print head includes the defective element.

As illustrated in FIG. 17, in the light quantity measurement result if the correction value is constant (at the second reference value), the light quantity measurement result for the defective element is significantly below the target light quantity. Therefore, as illustrated in FIG. 18, the correction value for the defective element becomes a large value. However, as illustrated in FIG. 19, the corrected light quantity for the defective element (output after correction is applied) remains significantly below the target light quantity. Furthermore, a light emitting element operated immediately after the defective element is now adversely affected by the attempted correction of the defective element, and the light quantity of the otherwise normal light emitting element now exceeds the target light quantity. In other words, now two elements (the defective element and the otherwise normal element operated after the defective element), are not emitting light at the target light quantity.

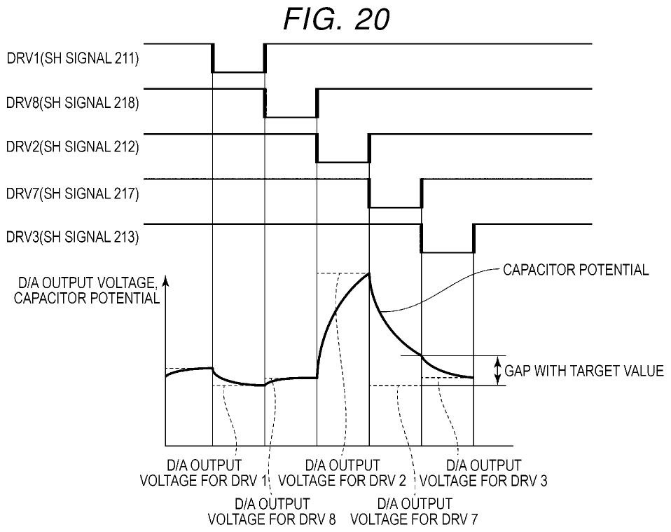

FIG. 20 is a view illustrating an effect of setting an inappropriate voltage with the first light quantity correction.

A case where the potential set between the terminals of the capacitor of the DRV 2 is extremely large will be described. The output voltage (broken line in graph) of the D/A conversion circuit 153 changes depending on the correction value calculated from each light quantity measurement result. If the light emitting element 131 connected to the DRV 2 is a defective element, the light quantity measurement result will be an extremely small value, and thus the correction value for the DRV 2 (which corresponds to output voltage of the D/A conversion circuit 153) will be the maximum value. As a result, the voltage across the capacitor terminals of the DRV 2 will be an extremely large voltage as compared with the capacitor inter-terminal voltage of other drive circuits DRV that are not defective.

If the correction value for the DRV 7 is an average level, the next voltage output by the D/A conversion circuit 153 will be the average level rather than the maximum level. However, if the potential change (discharge) ability of the D/A conversion circuit 153 is not sufficient, the potential might not be changed in time and the actual potential set for the DRV 7 will be higher than the target value (that is, a gap between actual and target value is generated). As a result, the light quantity from the light emitting element 131 connected to the DRV 7 becomes larger than the target level. In this manner, in the first light quantity correction, the light emitting elements 131 other than the defective element (s) may also emit light at a level different from the target level.

If the light quantity of the print head 10 is corrected by the first light quantity correction and a halftone image is to be output, white streaks may be generated since the light emitting element connected to the DRV 2 does not emit any light, but black/dark streaks are also generated since the light quantity of the light emitting element 131 connected to the DRV 7 is too large.

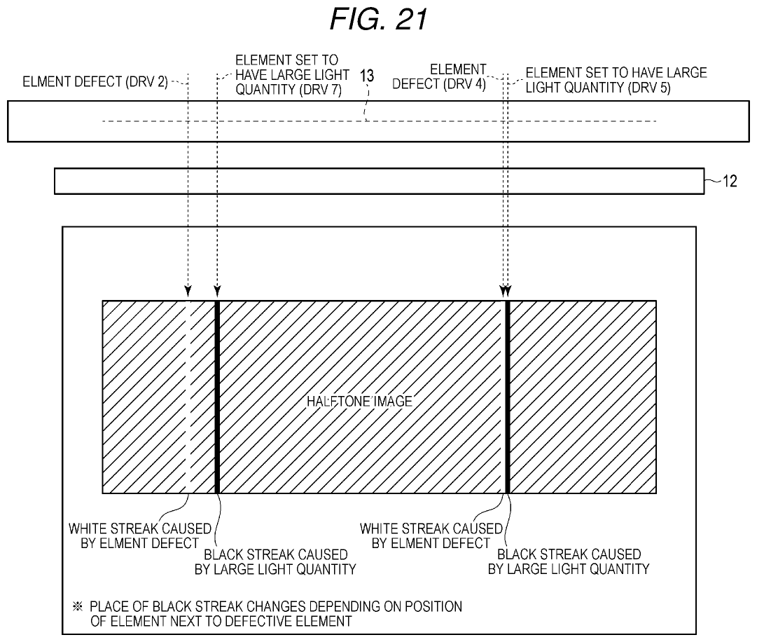

FIG. 21 is a view illustrating an effect on an image if just the first light quantity correction is applied to the print head including a defective element.

In a case of the halftone image, according to the first light quantity correction, white streaks appear corresponding to the defective elements, and black streaks appear corresponding to the effect related to the application of the maximum correction value to the defective elements. The positional relationship between the white streaks and the black streaks is determined by the positional relationship between the defective element and the light emitting element 131 to be controlled immediately after the defective element. In other words, the positional relationship between the white streaks and the black streaks changes depending on the positional relationship between the defective element and the next light emitting element 131 controlled to emit light directly after the defective element. In FIG. 21, as an example, a case (left image portion) where a location that corresponds to the DRV 2 becomes a white streak and a location that corresponds to the distanced DRV 7 becomes a black streak, and a case (right image portion) where a location that corresponds to DRV 4 becomes a white streak and a location that corresponds to the adjacent DRV 5 becomes a black streak (right), are illustrated.

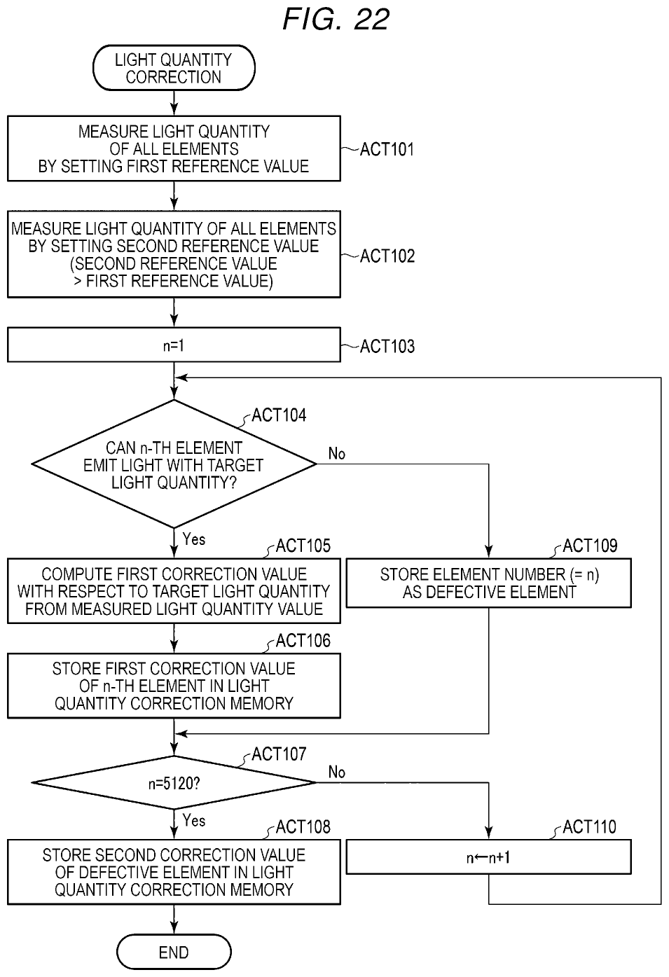

FIG. 22 is a flowchart illustrating an example of a second light quantity correction method for a print head according to an embodiment. The second light quantity correction method is a light quantity correction method that suppresses a defect (e.g., the generation of black streaks) that might otherwise be caused by the first type light quantity correction method by the application of an attempted correction value to the defective element(s).

The light emission controller 200 (also referred to as a voltage controller circuit) controls the light emission of all of the light emitting elements 131 according to the first reference value. The light quantity measurement sensor 19 detects the light quantity from the light emitting element 131 that corresponds to the light emission control of the light emission controller 200, and outputs a detection signal. The light emission controller 200 moves the light quantity measurement sensor 19 according to the light emitting elements 131 that emits light and measures the light quantity from all of the light emitting elements 131 (ACT 101).

Next, the light emission controller 200 controls the light emission of all of the light emitting elements 131 by the second reference value (second reference value>first reference value). The light quantity measurement sensor 19 detects the light quantity emitted from the light emitting elements 131 and outputs a detection signal. The light emission controller 200 moves the light quantity measurement sensor 19 and measures the light quantity from all of the light emitting elements 131 (ACT 102).

As the reference value increases, the D/A output voltage from the D/A conversion circuit 153 increases. As the D/A output voltage increases, the inter-terminal voltage of the capacitor 142 increases. As the inter-terminal voltage of the capacitor 142 increases, the emitted light quantity of the light emitting element 131 increases. In the present embodiment, a case where the light emission controller 200 corrects the light quantity based on use of just two reference values will be described, but the light quantity may be corrected based on one or three or more reference values in other examples.

In order to perform the light quantity correction for all of the light emitting elements 131, the light emission controller 200 sets the element number n (n=1 to 5120) of the light emitting elements 131 (ACT 103). For example, the light emission controller 200 initially sets n=1 and then corrects the light quantity in numerical order up to the final n-th element.

The light emission controller 200 determines whether or not each n-th element is an element that displays a correlation between capacitor voltage and the quantity of light emitted by the element and can also emit light at a target light quantity (ACT 104). As described with reference to FIG. 13, determination whether or not the n-th element is an element that displays a correlation between capacitor voltage and the light quantity and can also emit light at the target light quantity, is determination on whether or not the point indicating the light quantity with respect to the first reference value and the point of the light quantity with respect to the second reference value are connected to each other by a straight line and the point at which the straight line intersects the target light quantity is within the range of the correction value that can be set. In other words, an element such as the element A and the element B in FIG. 13 is determined to be an element that can emit light with a target light quantity, and an element such as the element C is determined to be an element that cannot emit light at a target light quantity.

If the light emission controller 200 determines that the n-th element is an element displays a correlation between the capacitor voltage and the light quantity and can also emit light at the target light quantity (ACT 104, YES), the correction value for setting the light quantity of the n-th element to the target light quantity is computed as the first correction value based on the first reference value and a first measured light quantity with respect to the first reference value and the second reference value and a second measured light quantity with respect to the second reference value (ACT 105). The light emission controller 200 writes the computed first correction value into an element number address n of the light quantity correction memory 18 (ACT 106).

If the light emission controller 200 determines that the n-th element displays no (or substantially no) correlation between the capacitor voltage and the light quantity o and cannot emit light at the target light quantity (ACT 104, NO), the element number and defect information are stored indicating the n-th element is a defective element (ACT 109).

If the light emission controller 200 has not yet finished determining whether or not all of the light emitting elements 131 can emit light with a target light quantity, that is, until n=5120 (ACT 107, NO), the light emission controller 200 increments the value of n (ACT 110), and repeats the processing after ACT 104. Once the light emission controller 200 finishes for all of the light emitting elements 131 (when n=5120) (ACT 107, YES), the light emission controller 200 stores the second correction value to the element number address stored in ACT 109 of the light quantity correction memory 18 (ACT 108). For example, the light emission controller 200 sets the second correction value between the maximum value and the minimum value of the first correction value, and writes the set second correction value into the light quantity correction memory 18. The second correction value may be an average value of the first correction values, or may be a value in the range of ±3% of the average value of the first correction values. In short, the second correction value may be a correction value that does not adversely affect the light quantity of the other light emitting elements. For example, the fluctuation of the light quantity that affects the image is typically a fluctuation of ±3% or more. Therefore, the second correction value may be a value that does not cause a fluctuation of ±3% or more in the light emitting elements other than the defective element.

The target light quantity and the light quantity fluctuation allowable range can be set arbitrarily at the printer/print head design stage.

In this manner, the light emission controller 200 executes the second light quantity correction. In general, if an element actually emits light, a light quantity correction value (first correction value) with which the element will emit light at the target light quantity is stored at an address in the light quantity correction memory 18 that corresponds to this normal (non-defective pixel) light emitting element 131. The first correction value is a value that determines capacitor voltage in the corresponding DRV circuit 140 for the element. The light quantity from the light emitting element 131 assumes the light emitting element faces the rod lens array 12. At the address in the light quantity correction memory 18 that corresponds to a defective element, a light quantity correction value (second correction value) that will not affect the light quantity emitted from the next light emitting element (subsequent stage light emitting element) is stored. The second correction value is a value that sets the capacitor voltage in the corresponding DRV circuit 140 to be within a predetermined range. In particular, the second correction value sets the capacitor voltage to a value that does not affect the voltage of the next capacitor to be charged in a DRV circuit 140. In general, the light quantity emitted by a defective element will not reach the target level no matter what the capacitor voltage is set to in the corresponding DRV circuit 140, as such, the second correction value can be selected such that emissions from other (non-defective) light emitting elements will not be adversely affected.

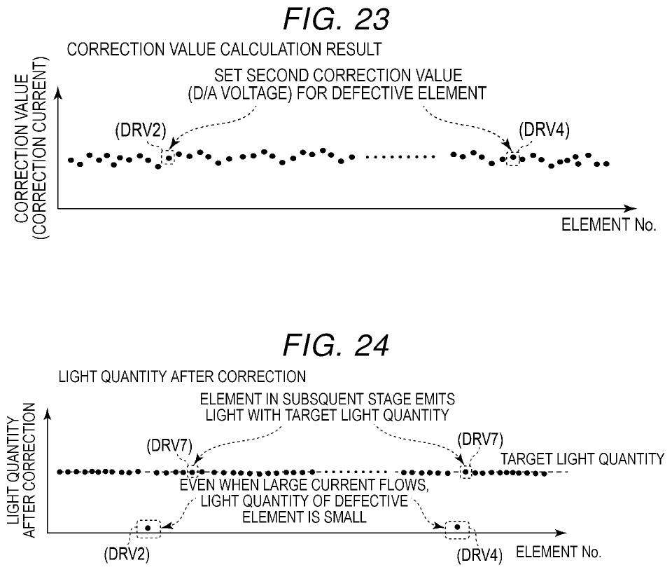

FIG. 23 is a view illustrating an example of the correction value computed by the second light quantity correction method when the print head includes a defective element. A correction value (a second correction value) of approximately the same level as that of other, non-defective light emitting elements is set for the defective element.

FIG. 24 is a view illustrating an example of the light quantity after the second light quantity correction method is applied. Light emitting elements of a print head are caused to emit light by the light emission controller 183 of the control substrate 101 of the image forming apparatus 100 after the second light quantity correction method is applied.

As illustrated in FIG. 24, the corrected light quantity that corresponds to the defective element still remains significantly below the target light quantity, but the light emitting element in the subsequent stage after the defective element emits light at the target light quantity.

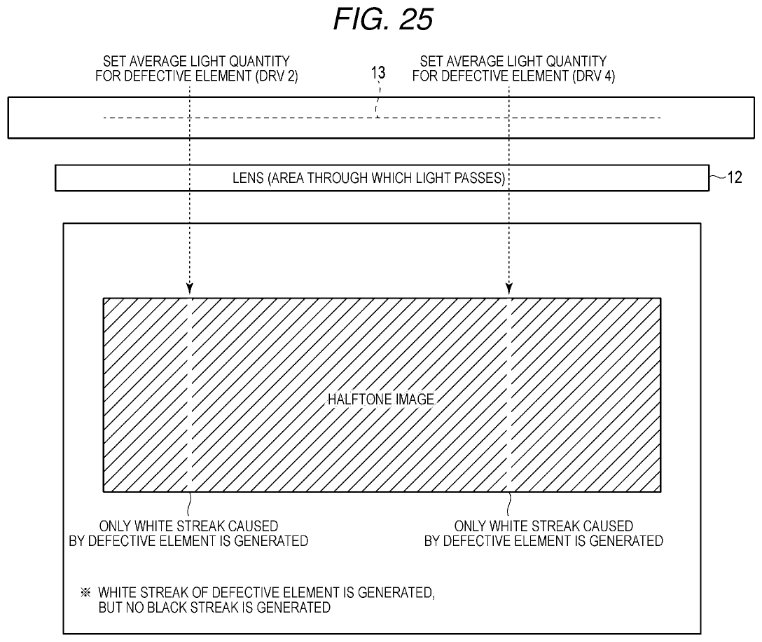

FIG. 25 is a view illustrating an effect on an image when the second light quantity correction is applied to a print head including a defective element.

When comparing FIGS. 21 and 25, in a case of a halftone image, according to the second light quantity correction, white streaks appear in response to the defective element similar to the first light quantity correction, but it is possible to prevent black streaks from appearing corresponding to the effect of the correction value of the defective element unlike the first light quantity correction.

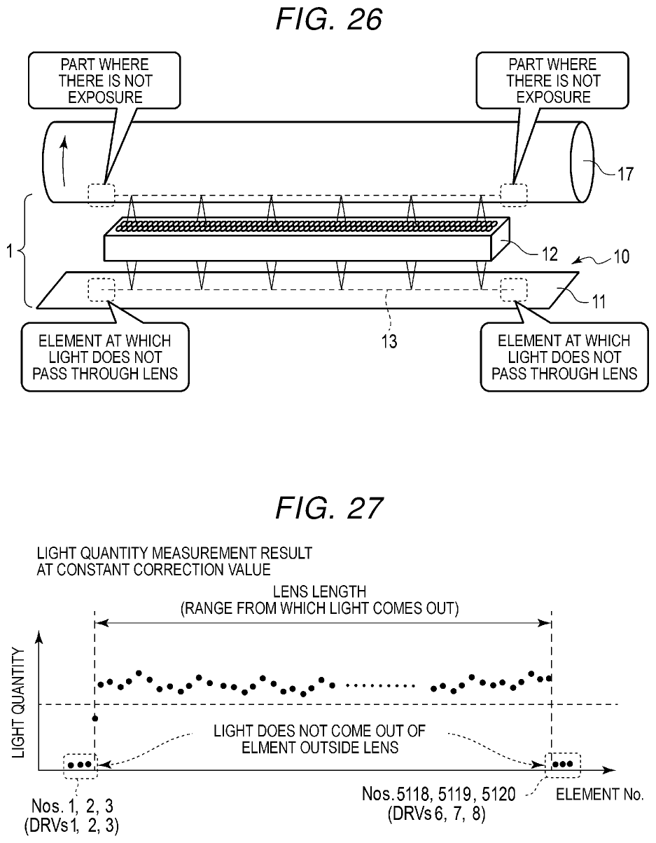

FIG. 26 is a view illustrating an example of a case where the light emitting element row of the print head is longer than the rod lens array and thus the measured light quantity that corresponds to the light emitting elements at both ends of the row is an extremely small value.

As illustrated in FIG. 26, if the light emitting element row 13 is longer than the rod lens array 12, the light from the light emitting elements 131 at the ends of the light emitting element row 13 does not pass through the lens of the rod lens array 12. When light from a light emitting element 131 does not pass through the rod lens array 12, the light does not effectively expose the photoreceptor drum 17. Furthermore, the measured light quantity from the light emitting element 131 outside the region of the rod lens array 12 will be an extremely small value, and as a result, the correction value for such a light emitting element 131 will be an extremely large value. In other words, a light emitting element 131 outside the lens region of the rod lens array 12 provides a measured light quantity that is low even if the circuit or the element is not actually defective, and thus, the similar defective images resulting from attempted correction of a defective element may occur.

FIG. 27 is a view illustrating an example of a light quantity measurement result of a case where the print head includes light emitting elements outside the lens region.

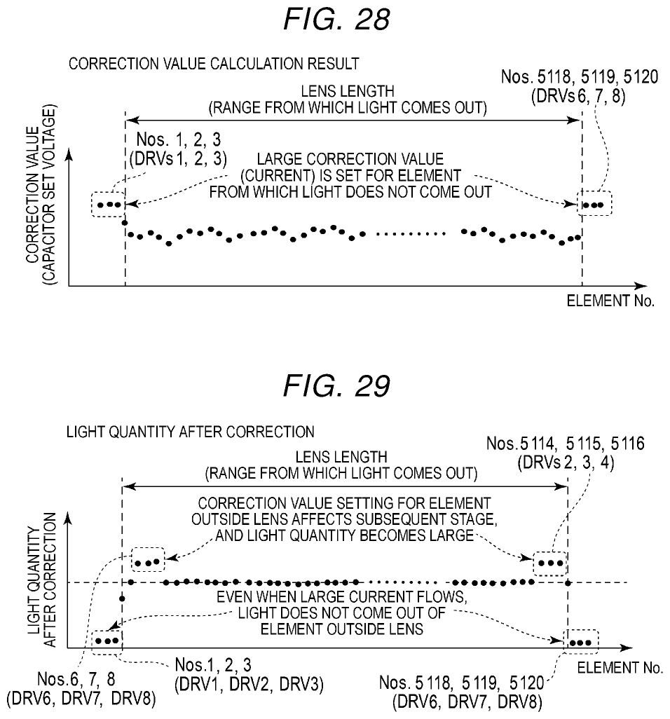

Element Nos. 1, 2, and 3 and element Nos. 5118, 5119, and 5120 are positioned outside the lens region. The DRV 1, the DRV 2, and the DRV 3 of the first group and the DRV 6, the DRV 7, and the DRV 8 of the 640-th group are connected to these light emitting elements. FIG. 28 is a view illustrating an example of the correction value computed by the first light quantity correction method. FIG. 29 is a view illustrating an example of the light quantity after the first light quantity correction is applied.

As illustrated in FIG. 27, in the light quantity measurement result if the applied correction value is constant, the light quantity measurement result that corresponds to the light emitting elements outside the lens region (the light emitting elements 131 connected to the DRV 1, the DRV 2, and the DRV 3 on the left side of FIG. 27 and the DRV 6, the DRV 7, and the DRV 8 on the right side of FIG. 27) will be significantly below the target light quantity. Therefore, as illustrated in FIG. 28, the correction value calculation result for those light emitting elements 131 outside the lens region becomes a large value. However, as illustrated in FIG. 29, the corrected light quantity for the light emitting elements 131 outside the lens region will still remain significantly below the target light quantity. The light emitting elements 131 within the lens region but within the same light emitting group 161 as those light emitting elements 131 outside the lens region, may be affected and emit light that exceeds the target light quantity when driven immediately after one of the light emitting elements 131 outside the lens region. This occurs because the setting order cycle of the capacitor inter-terminal voltage within each light emitting group 161 is the DRV 1, the DRV 8, the DRV 2, the DRV 7, the DRV 3, the DRV 6, the DRV 4, and then the DRV 5.

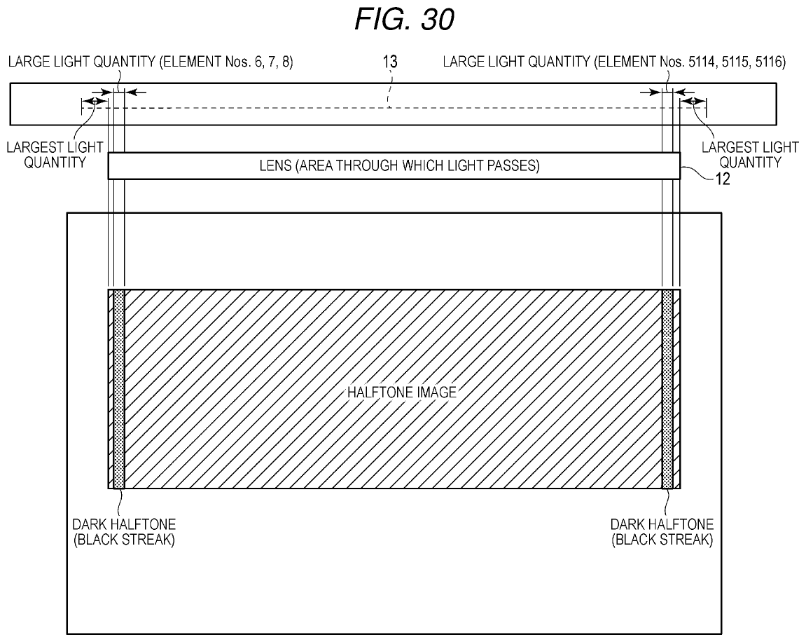

FIG. 30 is a view illustrating an effect on an image if just the first light quantity correction is applied to the print head 10 including light emitting elements 131 outside the lens region.

In a case of a halftone image, even if a light emitting element 131 outside the lens region emits light at its maximum light quantity, there is no effect on the halftone image, but the light emitting elements 131 in the same light emitting group 161 as these outside the lens region elements but themselves within the lens region will be affected by the attempted correction of the emission level of the outside lens region elements, and black/dark halftone (black streaks) appear. The element Nos. 6, 7, and 8 and the element Nos. 5114, 5115, and 5116 demonstrate to this effect.

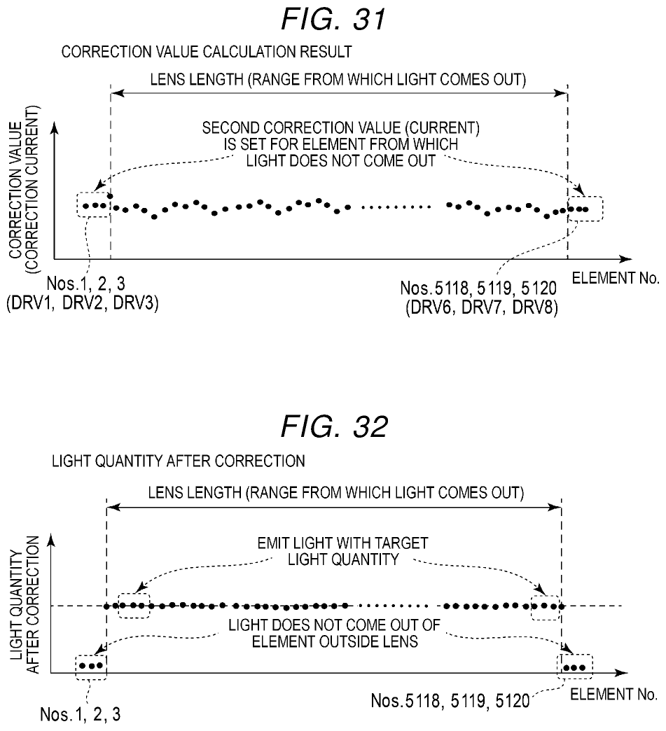

FIG. 31 is a view illustrating an example of the correction value computed by the second light quantity correction in a case where the print head includes some light emitting elements 131 outside the lens region. The correction value (second correction value) of the same level as that of other light emitting elements 131 is also set for the outside lens region light emitting elements 131 (the element Nos. 1, 2, and 3 and the element Nos. 5118, 5119, and 5120). Such a set value is stored in the light quantity correction memory 18 of the print head 10 on which the second light quantity correction is performed.

FIG. 32 is a view illustrating an example of the light quantity after the second light quantity correction is applied.

As illustrated in FIG. 32, it is possible to eliminate the effect on the in lens region light emitting elements 131 (for example, the light emitting elements 131 connected to the DRV 8, the DRV 7, and the DRV 6 of the first group or the DRV 4, the DRV 3, and the DRV 2 of the 640-th group) in the same light emitting element group 161 as certain light emitting elements 131 (for example, the light emitting elements 131 connected to the DRV 1, the DRV 2, and the DRV 3 of the first group or the DRV 6, the DRV 7, and the DRV 8 of the 640-th group) outside the lens region, and it is possible to cause the light emitting element (the element Nos. 6, 7, and 8 and the element Nos. 5114, 5115, and 5116) to emit light at a target light quantity.

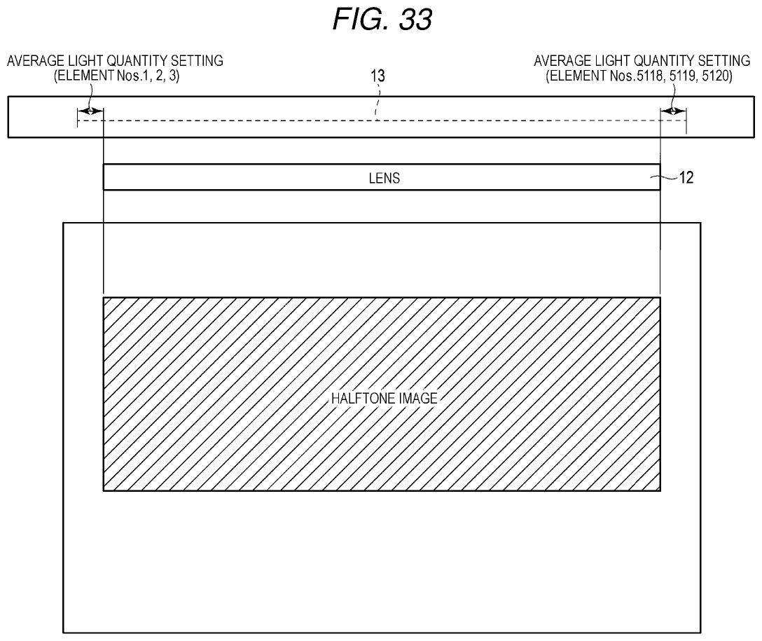

FIG. 33 is a view illustrating an effect on the image if the second light quantity correction is applied to the print head 10 having light emitting elements 131 outside the lens region. The light quantity of the light emitting elements 131 within the lens region substantially becomes constant.

When comparing FIGS. 30 and 33, for a halftone image, it is possible to prevent black streaks from appearing by application of the second light quantity correction as opposed to just the first light quantity correction.

It is thus possible to provide a print head 10 and an image forming apparatus 100 that prevent deterioration of image quality. In other words, the print head 10 and the image forming apparatus 100 select the first or second correction value depending on whether or not there is a correlation between the reference value and the measured light quantity that corresponds to the reference value (whether or not the light can be emitted with the light quantity within a predetermined range including the target light quantity). If there is a correlation (the light can be emitted with the light quantity within a predetermined range including the target light quantity), the latent image can be exposed with a target light quantity using the first correction value. If there is no correlation (the light cannot be emitted with the light quantity within a predetermined range including the target light quantity), the latent image can be exposed with a light quantity that reduces the effect on other factors using the second correction value.

If the correction value becomes large in an embodiment, the voltage set between the capacitor terminals rises and the light quantity increases. However, depending on the differences in the circuit configuration or the like, a case where a relationship between the correction value, the capacitor voltage, and the light quantity is different, can also be considered. For example, if when the correction value increases the capacitor voltage decreases, and the light quantity increases, then the magnitude relationship between the correction value and t capacitor voltage will have an opposite relationship from that of the example embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A print head, comprising:
a lens;
a substrate facing the lens;
a first light emitting element on the substrate at a position facing the lens and having a light output level that is controllable by current control to be within a predetermined range;
a second light emitting element on the substrate having a light output level that is not controllable by current control to be within the predetermined range;
a first driving circuit connected to the first light emitting element to supply current to the first light emitting element;
a first capacitor in the first driving circuit, the current supplied to the first light emitting element by the first driving circuit being set by the inter-terminal voltage of the first capacitor;
a second driving circuit connected to the second light emitting element to supply current to the second light emitting element;
a second capacitor in the second driving circuit, the current supplied to the second light emitting element by the second driving circuit being set by the inter-terminal voltage of the second capacitor; and
a memory storing a first correction value for the setting of the inter-terminal voltage of the first capacitor and a second correction value for the setting of the inter-terminal voltage of the second capacitor, wherein
when the inter-terminal voltage of the first capacitor is set according to the first correction value, the light output level of the first light emitting element is within the predetermined range, and
when the inter-terminal voltage of the second capacitor is set according to the second correction value, the inter-terminal voltage of the second capacitor is less than a predetermined threshold level.

2. The print head according to claim 1, wherein the second light emitting element is at a position facing the lens.

3. The print head according to claim 1, wherein the second light emitting element is at a position not facing the lens.

4. The print head according to claim 1, wherein
the first light emitting element and the second light emitting element are in a row of a plurality of light emitting elements on the substrate, and
the predetermined threshold level is a level at which the light output level of any other light emitting element in the plurality of light emitting elements driven after the second light emitting element would be caused to be outside the predetermined range.

5. The print head according to claim 4, wherein the second light emitting element is at an end of the row.

6. The print head according to claim 4, wherein the lens is a rod-shaped lens parallel to the row.

7. The print head according to claim 1, further comprising:
a light amount sensor configured to measure light output levels of the first and second light emitting elements.

8. The print head according to claim 7, further comprising:
a voltage control circuit configured to receive the measured light output levels from the light amount sensor and write the first and second correction values to the memory according to the measured output levels.

9. A print head, comprising:
a plurality of light emitting elements on a substrate, each light emitting element having a driving circuit including a capacitor;
a voltage controller circuit configured to charge the capacitor of each driving circuit according to a determined output level of the respectively corresponding light emitting element, wherein
the voltage controller circuit:
charges the capacitor of each driving circuit having a corresponding light emitting element that has a determined output level within a predetermined controllable range such that the corresponding light emitting element has a resulting light output level that is substantially equal to a first value, and
charges the capacitor of any driving circuit having a corresponding light emitting element that has a determined output level outside the predetermined controllable range such that the voltage of the capacitor is less than a maximum threshold value.

10. The print head according to claim 9, wherein the voltage controller circuit reads a charging level value for each capacitor of the driving circuits for the plurality of light emitting elements from a memory.

11. The print head according to claim 10, wherein the voltage controller circuit receives the determined output levels for each of the light emitting elements and stores the charging level values for each capacitor of the driving circuits for the plurality of light emitting elements in the memory.

12. The print head according to claim 9, further comprising:
a light sensor configured to determine output levels for each of the plurality of light emitting elements.

13. The print head according to claim 9, further comprising:
a lens facing the plurality of light emitting elements.

14. The print head according to claim 9, further comprising:
a rod-shaped lens facing the plurality of light emitting elements.

15. The print head according to claim 9, wherein the plurality of light emitting elements are arranged in a row on the substrate.

16. The print head according to claim 9, further comprising:
a lens facing a first light emitting element in the plurality of light emitting elements; and
a second light emitting element in the plurality of light emitting elements, the second light emitting element not facing the lens, wherein
the voltage controller circuit is configured to charge the capacitor of the second light emitting element such that the voltage of the capacitor of the second light emitting element is less than the maximum threshold value.

17. An image forming apparatus, comprising:
a photoreceptor drum;
a rod-type lens parallel to an axial direction of the photoreceptor drum;
a plurality of light emitting elements on a substrate facing the rod-type lens, the plurality of light emitting elements positioned to emit light towards the photoreceptor drum;
a first light emitting element in the plurality of light emitting elements at a position facing the rod-type lens and having a light output level that is controllable by current control to be within a predetermined range;
a second light emitting element in the plurality of light emitting elements having a light output level that is not controllable by current control to be within the predetermined range;
a first driving circuit connected to the first light emitting element to supply current to the first light emitting element;
a first capacitor in the first driving circuit, the current supplied to the first light emitting element by the first driving circuit being set by the inter-terminal voltage of the first capacitor;
a second driving circuit connected to the second light emitting element to supply current to the second light emitting element;
a second capacitor in the second driving circuit, the current supplied to the second light emitting element by the second driving circuit being set by the inter-terminal voltage of the second capacitor; and
a memory storing a first correction value for the setting of the inter-terminal voltage of the first capacitor and a second correction value for the setting of the inter-terminal voltage of the second capacitor, wherein
when the inter-terminal voltage of the first capacitor is set according to the first correction value, the light output level of the first light emitting element is within the predetermined range, and
when the inter-terminal voltage of the second capacitor is set according to the second correction value, the inter-terminal voltage of the second capacitor is less than a predetermined threshold level.

18. The image forming apparatus according to claim 17, wherein the second light emitting element is at a position facing the rod-type lens.

19. The image forming apparatus according to claim 17, wherein the second light emitting element is at a position not facing the rod-type lens.

20. The image forming apparatus according to claim 17, wherein
the first light emitting element and the second light emitting element are in a row on the substrate, and
the predetermined threshold level is a level at which the light output level of any other light emitting element in the plurality of light emitting elements driven after the second light emitting element would be caused to be outside the predetermined range.
